(19) United States
(12) Patent Application Publication
(10) Pub. No.: US 2013/0132434 A1
(43) Pub. Date: May 23, 2013

(54) USER-ASSISTED IDENTIFICATION OF LOCATION CONDITIONS

(71) Applicants: Christopher L. Scofield, Seattle, WA (US); William J. Schwebel, Seattle, WA (US); Kevin Foreman, Sammamish, WA (US)

(72) Inventors: Christopher L. Scofield, Seattle, WA (US); William J. Schwebel, Seattle, WA (US); Kevin Foreman, Sammamish, WA (US)

(73) Assignee: INRIX, Inc., Kirkland, WA (US)

(21) Appl. No.: 13/302,640

(22) Filed: Nov. 22, 2011

(51) Int. Cl. G06F 17/30

(52) U.S. Cl. 707/771; 707/E17.014

(57) ABSTRACT

Location-based devices (e.g., GPS receivers) may be used to identify and track traffic conditions. However, such scenarios are difficult to extend to the identification of relevant facts other than traffic, such as road or weather conditions (e.g., debris, animals, or ice). Presented herein are techniques for receiving and aggregating reports of location-based conditions received from users, either spontaneously (“I just witnessed an accident”) or in response to a query (e.g., “did you encounter road ice one kilometer ago?”) From such reports, location conditions of respective locations may be automatically extracted (e.g., using natural-language parsing techniques), and users in the vicinity of or routing through a particular location may be automatically notified of location conditions (e.g., “ice reported one kilometer ahead”). Such systems may also communicate with users in a voice-only interface while the user is operating a vehicle, and may additionally receive and utilize vehicle telemetry to determine location conditions.

### BACKGROUND

Within the field of computing, many scenarios involve a set of users operating a set of location-aware devices, such as global positioning system (GPS) receivers having access to mapping information that is capable of providing routing information. In some of these scenarios, the devices may be configured to receive supplemental information that may be relevant the users, such as the presence of traffic along the route of the user that may provide a more accurate estimated time of arrival or the selection of an alternative route. Moreover, in some of these scenarios, the devices operated by the users may contribute to the generation of traffic information; e.g., the speeds of vehicles traveling along a particular span of roadway, may be detected to infer traffic conditions along the road span. Such scenarios may therefore involve the participation of the devices in the estimation of traffic conditions.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the involvement of user devices in traffic estimation scenarios may be helpful, conventional implementations of such concepts may present some limitations. As a first example, information about the speeds of vehicles traveling in a particular location may be inadequate to determine the conditions of the location, such as a cause of low travel speeds reported at the location (e.g., whether the traffic was caused by an ephemeral condition, such as the presence of a deer or other animal in the road; a lengthy condition, such as a traffic accident or large obstruction; or a permanent condition, such as road restructuring). Moreover, information about the conditions of the road may have greater value than traffic estimation, such as warning other users of confusing of dangerous conditions. However, these advantages may be difficult to achieve using only the sensory capabilities of the device, which may be unable to determine properties about the conditions of the location with accuracy.

Presented herein are techniques for generating and utilizing information about the conditions of locations, such as spans of roadway traveled by the users of location-aware devices. Such information may be received from the users of the devices, e.g., as a voice-based report of the conditions of a location that may be evaluated by a natural-language parser to extract information about the location conditions of the location. This information may be reported to a server configured to store location data, which may then transmit information about location conditions to other users in or approaching the same location. Moreover, the server may be configured to confirm, clarify, or identify additional details about a location condition by generating and presenting queries to users in the proximity of the location (e.g., through a voice-only interface that may be safely used during the operation of a vehicle by the user). These and other scenarios may enable the generation and consumption of information about location conditions in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring an estimation of traffic along a set of locations based on a detection of wireless devices broadcasting in each location.

FIG. 2 is an illustration of an exemplary scenario featuring a detection of location conditions of respective locations through the submission by users of location condition reports in accordance with the techniques presented herein.

FIG. 3 is a flow chart illustrating an exemplary first method of querying users regarding location conditions of locations.

FIG. 4 is a flow chart illustrating an exemplary second method of querying users regarding location conditions of locations.

FIG. 5 is an illustration of an exemplary computer-readable medium comprising processor-executable instructions configured to embody one or more of the provisions set forth herein.

FIG. 6 is an illustration of an exemplary scenario featuring a querying of a user to submit a location condition report based on a comparison of user characteristics of a location with historic user characteristics of the location.

FIG. 7 is an illustration of an exemplary scenario featuring a querying of a user to submit a location condition report based on telemetric data received from a vehicle operated by the user in the location.

FIG. 8 is an illustration of an exemplary scenario featuring a set of templates that may be used to generate queries soliciting users to submit location condition reports in various circumstances.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

The contemporary widespread availability of mobile devices has enabled a large number and variation of techniques and services based on such mobile devices. In particular, many devices are equipped to detect a location of the user, such as through the inclusion of a global positioning system (GPS) receiver in a navigation device, a mobile phone, or a tablet, and location-based services and techniques enable such devices to mediate the interaction of users with physical locations. For example, navigation devices may store or be configured to retrieve detailed travel maps of the locale, and may use a detected location to display the user's current location or to compute travel routes to intended destinations, and mobile phones may enable the user to communicate location-based information with other users, such as a shared map of the locations of the users. As a further example, mobile devices including a camera and gyroscopic sensors may present “augmented reality” applications by identifying the location and orientation of the view presented in the image, retrieving information about objects that may be depicted in the view (e.g., the presence and names of points of interest that are positioned within the view), and supplementing the image of the view with the retrieved information (e.g., labeling depicted points of interest with names).

Many such techniques and services are intended to assist travelers, such as vehicle passengers, bicyclists, and pedestrians, through the provision of location-based information. In particular, some of these services may be usable by the operator of a vehicle, such as the driver of an automobile, but it may be undesirable to configure the device with a highly interactive user interface that may interfere with the attention of the driver and the safe operation of the vehicle. For example, some navigation devices are configured to accept user interaction only when the vehicle is not moving, and switch into a non-interactive mode when the vehicle is in motion in order to discourage the driver from interacting with the device at such times.

One scenario for which techniques and services have been devised involves the estimation of traffic in a particular location based on the detection of the speeds of vehicles operating in the location. For example, traffic surveillance devices may detect the average speeds of individual vehicles traveling on a span of road, and may compute and report an average traffic speed. Alternatively, individual vehicles may include a device capable of detecting the speed of vehicle, such as a global positioning system (GPS) receiver, and may report the speed of the vehicle to a server, which may infer the traffic conditions at respective locations from the speeds of vehicles for the location. Such traffic information in realtime may be highly valuable to motorists to assist with routing; e.g., motorists may seek to reduce traffic delays or to find the briefest route from a current location to a destination, and the incorporation of traffic congestion may provide more accurate predictive routing. As one exemplary service, traffic congestion information for a region may be broadcast on a traffic message channel (e.g., transmitted via AM or FM radio bands, shortwave transmission, or satellite), and may be received by traffic message channel (TMC) receivers included in navigation devices, which may compute or adjust routes based on the realtime traffic congestion information encoded in the transmission. Alternatively, devices equipped with network communication devices, such as wireless internet transceivers, may be configured to retrieve such information from traffic congestion information servers accessible over the internet.

Various techniques have also been devised to estimate traffic congestion in such locations. As a first example, devices may automatically count the number and frequency of cars crossing a sensor embedded in the road, or may estimate the average speed of vehicles along a span of road, and may transmit such information to a central data source for aggregation and rebroadcast to the devices of users. However, such techniques may be comparatively expensive to deploy and maintain, particularly with a high density that provides precise data for respective short road spans.

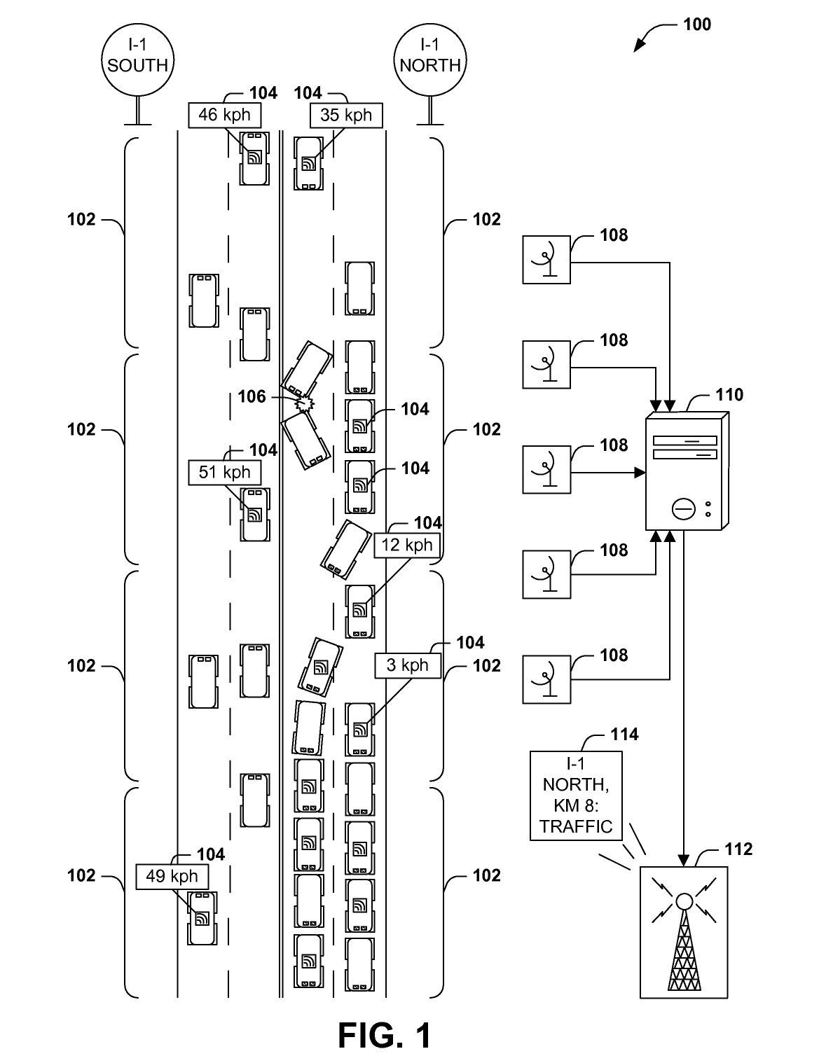

FIG. 1 presents an illustration of an exemplary scenario 100 featuring another exemplary technique for estimating traffic congestion based on the detection of mobile devices that are wirelessly broadcasting in a location. In this exemplary scenario 100, in particular locations 102 (e.g., short spans of road along a highway), a number of automobiles may be operating at a particular volume. This volume may be affected by a location condition 106, such as a traffic accident, a road hazard (e.g., a pothole, an animal such as a deer, or debris), or a weather condition (e.g., heavy rain, ice, or hail). It may be presumed that a particular percentage of motorists own and operate a wireless communication device, such as mobile phones, tablets, laptop computers, media devices, two-way radios, or navigation devices. The wireless broadcasts 104 from such devices may be detected (e.g., by the transceivers 108 configured to communicate with such devices, such as cellular network towers), and, by factoring in an estimate of the number of devices utilized by a population of motorists, an estimate of traffic volume in each location 102 may be generated. Thus, in the exemplary scenario 100 of FIG. 1, an accident may have caused a location condition 106 that results in a travel obstruction and heavy traffic congestion in a particular set of locations 102, such as particular spans of a highway, while travel past the location condition 106 and in the opposite direction continues unimpeded and with only light traffic volume. Although unable to detect the presence or type of location condition 106, transceivers 108 may estimate the number of devices emitting a wireless broadcast 104 in each location 102, and may extrapolate that the locations 102 leading up to a particular location are exhibiting heavy traffic congestion, while other locations 102 present unimpeded traffic flow. This information may be reported to a server 110, which may use a transmitter 112 to transmit a traffic report 114 indicating the estimated traffic congestion in respective locations 102 of the highway. The traffic report 114 may be received by devices operated by the motorists (e.g., the same devices issuing wireless broadcasts 104 or different devices), and may be utilized to adjust routes and estimated arrival times in view of realtime and developing traffic conditions.

While the exemplary scenario 100 of FIG. 1 presents some advantages, such scenarios may present opportunities to collect additional information that may present significant utility. In particular, in addition to determining the speed of vehicles, and therefore traffic, in a particular location 102, it may be advantageous to determine the cause of the traffic. For example, a location condition 106 resulting in traffic may be momentary (e.g., an animal such as a deer briefly occupying a roadway), brief (e.g., a low-speed traffic accident where motorists stop briefly to assess damage, exchange information, and depart), protracted (e.g., a high-speed traffic accident where vehicles are towed away), or permanent (e.g., construction that alters traffic volume for an extended period of time). Such details about the traffic may be advantageous for predicting the magnitude and duration of the traffic congestion and adjusting routing information (e.g., a device presenting a route to a user may receive an indication of traffic congestion at a distant point along the route, but may determine whether or not to suggest a different route based on the predicted duration of the location condition 106 causing the traffic). Such information may also be useful or predicting future traffic congestion based on a newly arising location condition 106, even if traffic congestion has not yet developed. Additionally, detailed information about location conditions 106 may present significant utility beyond the estimation of traffic. For example, harmless location conditions 106, such as construction or minor traffic accidents, may not prompt a device to re-route the user, but dangerous location conditions 106, such as blizzards, ice, or major traffic accidents resulting in extensive debris, may result in re-routing. Moreover, such information about location conditions 106 may prompt re-routing even in the absence of traffic congestion; e.g., roadway ice presented at a particular location 102 that is not heavily traveled may not result in heavy traffic, but detecting and reporting such location conditions 106 may enable devices to warn users in the vicinity of the location 102 or to re-route around the location 102 in order to reduce hazards.

However, it may be difficult to identify the type or details of a location condition 106 using contemporary traffic congestion techniques, which detect only a counting of wireless broadcasts 104 in a particular location 102 in order to determine traffic congestion. For example, in the exemplary scenario 100 of FIG. 1, the detection of the presence of a large number of wireless broadcasts 104 in a particular location 102 may fail to indicate anything about the location condition 106 causing the traffic congestion, such as a precise location of the location condition 106 (e.g., in a particular lane, at the edge or in the median of a roadway, or to the left, right, above, or below the roadway); the projected duration of the location condition 106, the severity of the location condition 106, or the danger to motorists traveling within the location 102 comprising the location condition 106. More generally, it may be difficult to identify any such information in an automated manner based solely on devices, due to the large range of possible location conditions 106. For example, contemporary machine vision techniques may be capable of automatically interpreting visual input from cameras to identify the positions of automobiles, but may not be sufficiently advanced to identify a traffic accident depicted in such depictions, nor other location conditions 106 such as the presence of animals or debris.

### B. Presented Techniques

Presented herein are techniques for identifying, assimilating, and broadcasting information about location conditions 106 of respective locations 102 through the use of devices. In accordance with the techniques presented herein, it may be advantageous to involve the users of devices in the reporting of location conditions 106 through the submission of location condition reports, which may be received by a device operated by the user and transmitted to a server for inclusion in a location data set. A location condition report may be spontaneously provided by a user in response to a witnessing of a location condition 106, such as a user witnessing a traffic accident. In other circumstances, a device may query the user to provide a location condition report of location conditions 106 in the vicinity of the user; may couple such information with a detected location; and may submit the location condition report and the current location of the user to the server. Such techniques may be implemented in mobile devices to receive location condition reports for delivery to a server, which may develop a location data set comprising information comprising current location conditions 106 for a large number of locations 102, and transmit such information to the devices within a particular location in order to inform users of location conditions 106 in the current location 102 or along a current route of the user. Moreover, in order to reduce the distraction of the user (e.g., the attention of a motorist operating a vehicle), the devices may be configured to interact with users through a voice-only interface, involving spoken prompts presented to the user, and/or the receipt and automated evaluation of voice-based location condition reports to extract location conditions reported therein.

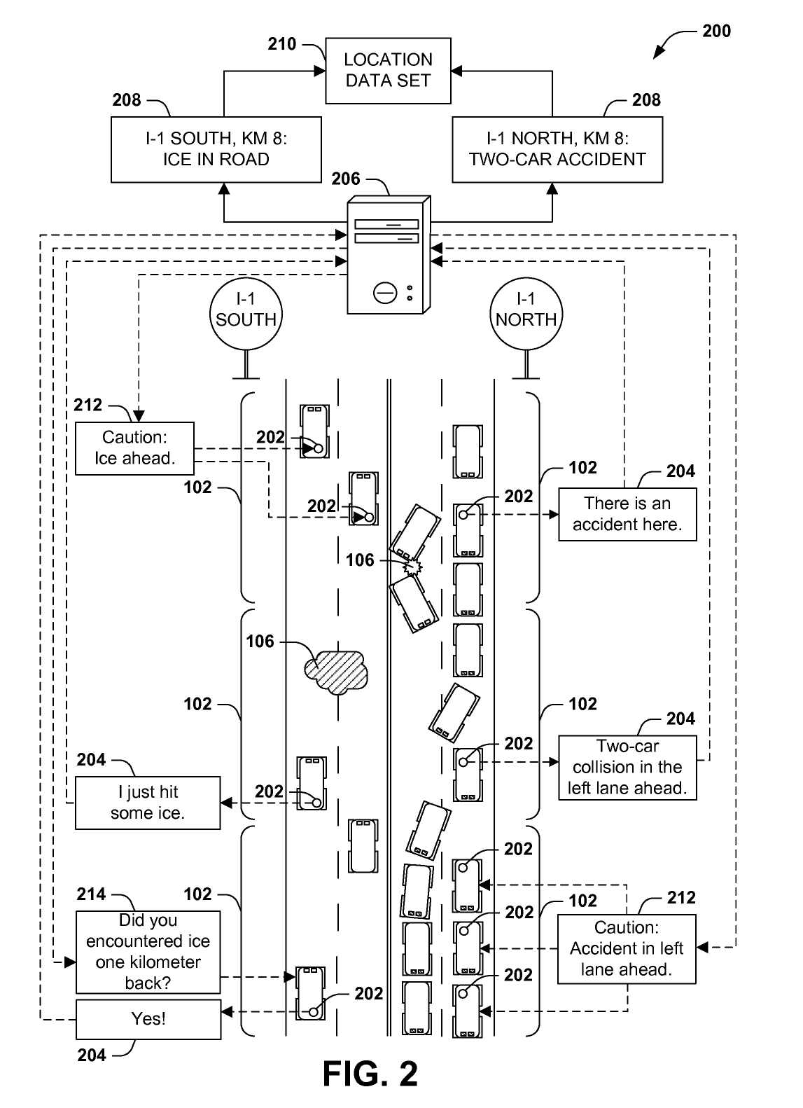

FIG. 2 presents an illustration of an exemplary scenario 200 featuring the collection from users 202 of location condition reports 204, the extraction of location conditions 106 for respective locations 102 from such location condition reports 204, and the delivery of location condition reports 204 to other users 202, according to the techniques presented herein. In this exemplary scenario 200, users 202 operating vehicles in respective locations 102 may encounter various types of location conditions 106, such as a traffic accident presented in a northbound roadway and the presence of ice in a southbound roadway. In accordance with the techniques presented herein, some users 202 are in possession of mobile devices that may be configured to receive a location condition report 204 from the users 202 describing a witnessed location condition 106; e.g., after navigating around the traffic accident (or waiting in traffic congestion caused by the traffic accident), users 202 may speak into the device to describe a more precise location (e.g., the left lane of the roadway), the type of location condition 106 (e.g., a traffic accident), and the severity of the location condition 106 (e.g., a low-speed collision of two vehicles). The device may receive the location condition report 204 of the user 202, and may deliver the location condition report 204 (or details extracted therefrom, e.g., detected keywords) to a server 206 having access to a location data set 210 configured to store location conditions 106 of respective locations 102. The server 206 may perform further evaluation of the information submitted by the devices, may extract information about location conditions 106 from such location condition reports 204, and may add the location conditions 106 to the location data set 210. The server 206 may also send notifications to users 202 near the locations 102 of such location conditions 106. For example, for users 202 located in the northbound roadway south of the traffic accident, the server 206 may send a notification 212 including details of the location condition 106 causing the traffic congestion. Moreover, the server 206 may interact with the devices and users 202 to determine more accurate or up-to-date information about a location condition 106. For example, in the southbound highway, a location condition 106 involving roadway ice may be described in a location condition report 204 newly submitted by a first user 202. In order to confirm the location condition report 204, the server 206 may identify other users 202 in the vicinity of the location 102 (e.g., users who have recently passed the location 102), may send to the devices of such users 202 a request to present a location condition query 214 to such users 202 to confirm the presence of the location condition 106 and to solicit additional details, and may incorporate location condition reports 204 responsive to such location condition queries 214 in the location data set 210. Upon confirming the location condition 106, the server 206 may also identify users 202 in the vicinity of the location condition 106 (e.g., users 202 traveling on the southbound highway who are approaching the location 102), and may send a notification 212 cautioning such users 202 about the location condition 106. In this manner, information about location conditions 106 of respective locations 102 may be collected (through the receipt and evaluation of location condition reports 204) and utilized in accordance with the techniques presented herein.

In comparison with other contemporary techniques, such as the traffic estimation technique presented in the exemplary scenario 100 of FIG. 1, the techniques presented herein may exhibit some advantages. As a first exemplary advantage, the techniques presented herein may result in more detailed and useful information about the types and causes of traffic congestion, which may result in more informed and more accurate estimates of arrival times and routing selection. As a second exemplary advantage, the information generated by the techniques presented herein may be included in a broad range of uses beyond traffic estimation and route selection, such as cautioning drivers of upcoming hazards, and informing authorities such as police, fire suppression, and medical teams of developing location conditions 106. As a third exemplary advantage, the information of users 202 who are capable of providing additional information about a location condition 106, and the solicitation of specific information therefrom, may result in more accurate, detailed, and up-to-date information than techniques that endeavor to infer information from devices. These and other advantages may be achievable through the application of the techniques presented herein.

### C. Exemplary Embodiments

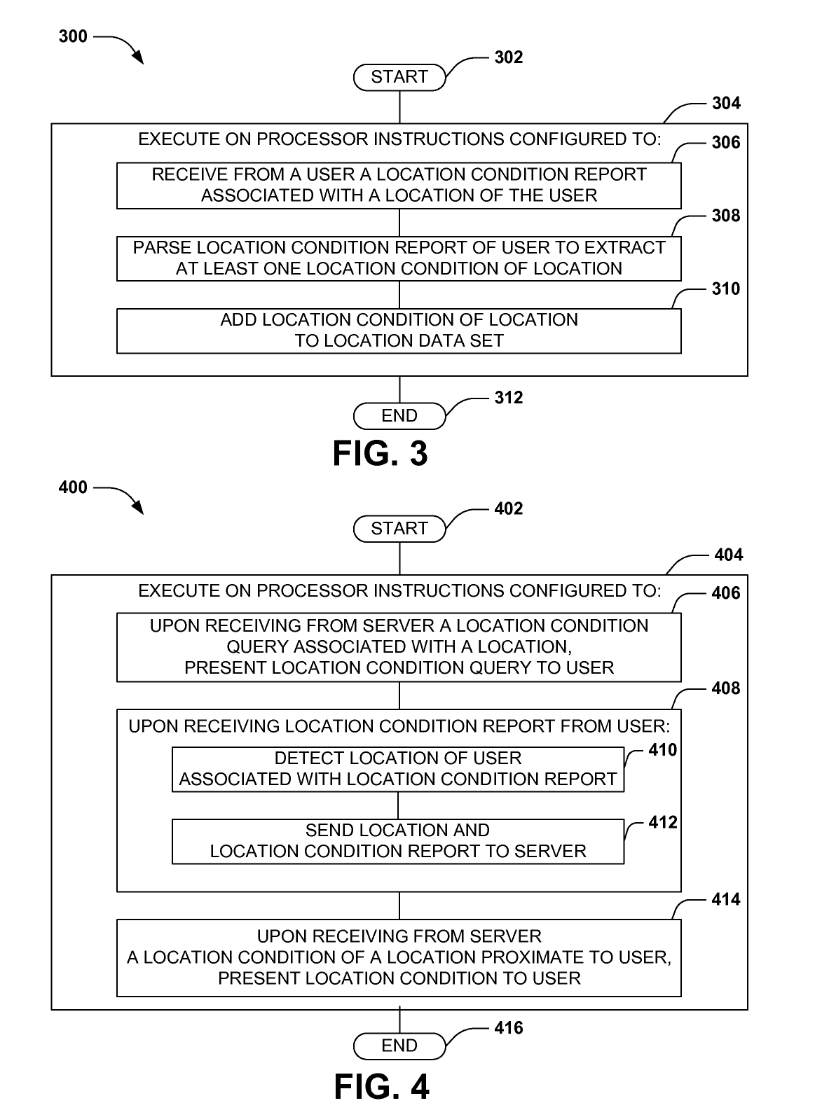

FIG. 3 presents a first exemplary embodiment of the techniques presented herein, illustrated as a first exemplary method 300 of querying users 202 regarding location conditions 106 of locations 102. The first exemplary method 300 may be implemented on a device having a processor and having access to a location data set 210 (which may be directly accessible, such as a locally stored data set, or may be accessible through a network or another device, such as a server). The first exemplary method 300 may be implemented, e.g., as a set of instructions stored in a memory component of a device (e.g., a memory circuit, a platter of a hard disk drive, a solid-state memory component, or a magnetic or optical disc) that, when executed by a processor of a device, cause the device to perform the techniques presented herein. The first exemplary method 300 begins at 302 and involves executing 304 the instructions on the processor. Specifically, the instructions are configured to receive 306 from a user 202 a location condition report 204 associated with a location 102 of the user 202. The instructions are also configured to parse 308 the location condition report 204 of the user 202 to extract at least one location condition 106 of the location 102. The instructions are also configured to add 310 the location condition 106 of the location 102 to the location data set 210. In this manner, the first exemplary method 300 achieves the identification of location conditions 106 of respective locations 102 through the receipt and evaluation of location condition reports 204 submitted by users 202 in accordance with the techniques presented herein, and so ends at 312.

FIG. 4 presents a second exemplary embodiment of the techniques presented herein, illustrated as a second exemplary method 400 of querying users 202 regarding location conditions 106 of locations 102. The second exemplary method 400 may be implemented on a device having a processor (e.g., a portable device such as a mobile phone, a tablet, a laptop or palmtop computer, a portable media device, a portable game device, or a navigation device) and communicating with a server 206 having access to a location data set 210. The second exemplary method 400 may be implemented, e.g., as a set of instructions stored in a memory component of a device (e.g., a memory circuit, a platter of a hard disk drive, a solid-state memory component, or a magnetic or optical disc) that, when executed by a processor of a device, cause the device to perform the techniques presented herein. The second exemplary method 400 begins at 402 and involves executing 404 the instructions on the processor. Specifically, the instructions are configured to, upon receiving from the server 206 a location condition query 214 associated with a location 102, present 406 the location condition query 214 to the user 202. The instructions are also configured to, upon receiving 408 a location condition report 204 from the user 202, detect 410 a location 102 of the user 202 associated with the location condition report 204, and send 412 the location 102 and the location condition report 204 to the server 206. The instructions are also configured to, upon receiving from the server 206 a location condition 106 of a location 102 proximate to the user 202, present 414 the location condition 106 to the user 202. In this manner, the second exemplary method 400 achieves the identification of location conditions 106 of respective locations 102 through the receipt and evaluation of location condition reports 204 submitted by users 202 in accordance with the techniques presented herein, and so ends at 416.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

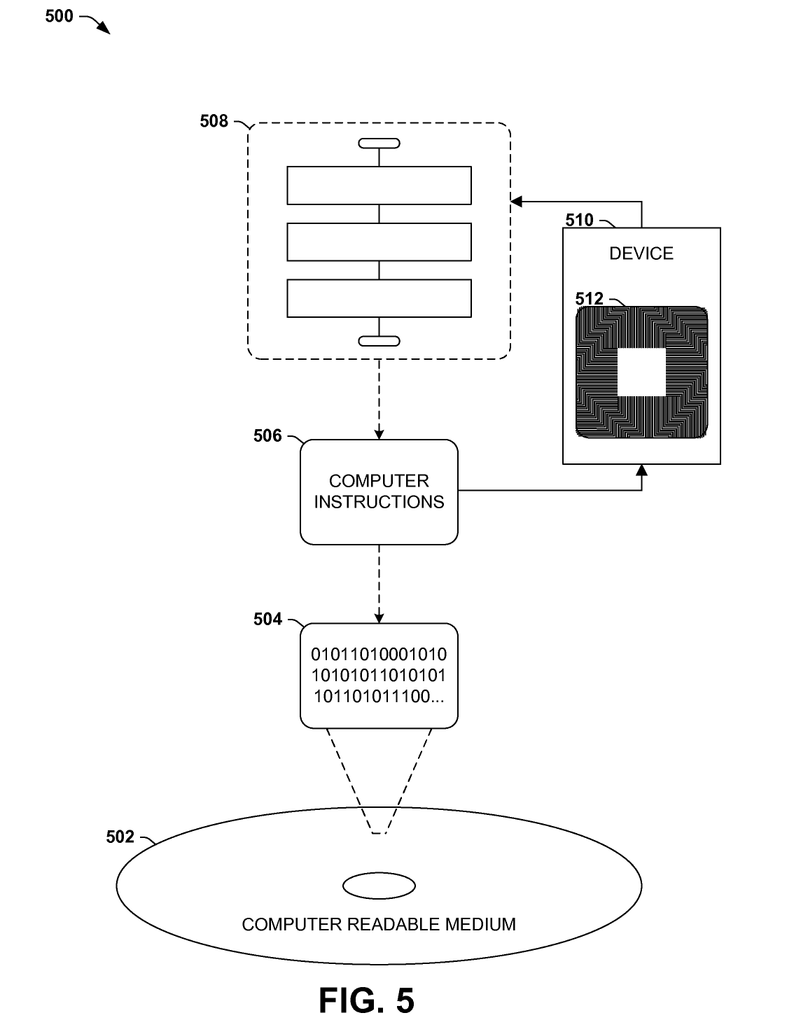

An exemplary computer-readable medium that may be devised in these ways is illustrated in FIG. 5, wherein the implementation 500 comprises a computer-readable medium 502 (e.g., a CD-R, DVD-R, or a platter of a hard disk drive), on which is encoded computer-readable data 504. This computer-readable data 504 in turn comprises a set of computer instructions 506 configured to operate according to the principles set forth herein. In one such embodiment, the processor-executable instructions 506 may be configured to, when executed by a processor 512 of a device 510, cause the device 510 to perform a method of querying users 202 regarding location conditions 106 of locations 102, such as the first exemplary method 300 of FIG. 3, or the second exemplary method 400 of FIG. 4. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### D. Variable Aspects

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the first exemplary method 300 of FIG. 3 and the second exemplary method 400 of FIG. 4 to confer individual and/or synergistic advantages upon such embodiments.

D1. Scenarios and Architectures

A first aspect that may vary among embodiments of these techniques relates to the scenarios wherein such techniques may be utilized. As a first variation of this first aspect, these techniques may be used to track many location conditions 106 for many types of locations 102, including travel and traffic conditions on roadways for motorists; travel conditions of pathways for bicyclists, pedestrians, and hikers; conditions of slopes for skiers, conditions of waterways for naval and maritime scenarios; and conditions of airways for aircraft pilots and other aviators. Such location conditions 106 for locations 102 may also be identified and reported to individuals other than travelers, such as reporting emerging events to police, fire, and medical professionals. Such location conditions 106 may also be used for locations 102 in simulated and/or virtual environments.

As a second variation of this first aspect, many types of location conditions 106 may be identified and reported for a particular type of location 102. As a first example, the location conditions 106 may include natural and/or weather conditions (e.g., temperature, wind, precipitation, humidity causing mist or fog, lightning, hail) or the effects thereof (e.g., visibility effects, breezing effects, the formation of ice or standing water, smoke, or fire). As a second example, the location conditions 106 may include information about natural inanimate objects (e.g., potholes, mud, trees, or landslides), artificial inanimate objects (e.g., vehicles, debris, substances such as oil, and downed power lines) and/or animals (e.g., the presence of wildlife in a roadway or dangerous animals on or near a pedestrian pathway). As a third example, the location conditions 106 may include information about individuals, such as the number, identification, condition, and/or behavior of individuals involved in a traffic accident.

As a third variation of this first aspect, the locations 102 to which a location condition report 204 pertains may be detected in many ways. As a first example, the device may comprise a location sensor, such as a global positioning system (GPS) receiver, and may detect and report the current location 102 of a user 202 while receiving a location condition report 204 therefrom. As a second example, the location 102 of the device may be detected by other devices; e.g., one or more transceivers 108 in wireless communication with a device transmitting a location condition report 204 may triangulate a position of the device. As a third example, the location 102 of a location condition report 204 may be specified by the user 202, e.g., as part of the location condition report 204 (“I encountered ice at mile 100 of southbound Interstate 1”). As a fourth example, the location 102 of the device may be inferred, e.g., based on a travel schedule of the device at the time of a location condition report 204, or a known and fixed location of the device.

As a fourth variation of this first aspect, the techniques presented herein may be implemented using various architectures. As a first example, the techniques may be entirely implemented by a device such as a server provided on the internet, or as a mobile device that collects, stores, and reports information (e.g., a navigation device configured to record location conditions 106 for later reporting). Alternatively, the techniques may be implemented by two or more devices interoperating in a peer-to-peer manner (e.g., navigation devices embedded in various vehicles that directly exchange information about location conditions 106 encountered by users 202) and/or a server-client manner (e.g., one or more mobile devices configured to receive location condition reports 204 from users 202 for forwarding to a server 206, as in the exemplary scenario 200 of FIG. 2). For example, the user 202 may operate a user device in communication with a location condition server that may receive location condition reports 204 and associated locations 102 from the user devices, and may present location condition queries 214 to the user devices for presentation to the users 202 thereof. As a second example of this fourth aspect, the server 206 may direct the interaction of devices with users 202, such as sending location condition queries to be presented to users 202 in order to solicit particular types of information (e.g., the clarification or supplementing of information previously received from the user 202, or the confirmation of location conditions 106 reported by other users 202). Alternatively, the devices may determine information that may be provided by the user 202, and may store, select, and/or generate queries that may be selected for presentation to the users 202. As a third example, the device may be in continuous or frequent communication with the server 206, or may be sporadically connected (e.g., the device may collect location conditions 106 during a journey, and may report the information to the server 206 at the conclusion of the journey). As a fourth example, the elements of the techniques presented herein may be allocated among such devices in various ways. As a first example, a user device may receive a location condition report 204 from a user 202 and may forward the entire location condition report 204 to the server 206 for evaluation and the extraction of location conditions 106. Alternatively, the user device may partially or wholly evaluate the location condition report 204, such as performing natural-language parsing, identifying narrative context, and/or identifying keywords, and may deliver structured data to the server 206.

As a fifth variation of this first aspect, the location data set 210 may be structured in many ways. As a first example, the location data set 210 may include many types of information, including various identifications of the locations 102 of interest (e.g., by latitude and longitude coordinates; by predefined names or descriptions, such as a street address of a building; or by ranges within known locations, such as road markers along an identified roadway) and information about the location condition reports (e.g., the date, time, and source of the location condition report 204; a textual or photographic description of the location condition; and the size, duration, priority or severity of the reported location condition). As a second example, one location data set 210 may comprehensively include all of the location conditions for all known locations 102. Alternatively or additionally, one or more location data sets 210 may be limited to a particular geographic area, geographic area type (e.g., a first location data set 210 for highways and a second location data set 210 for local roadways), duration (e.g., a first location data set 210 for ephemeral conditions, such as vehicle collisions, and a second location data set 210 for long-lasting conditions, such as long-term construction projects). A set of location data sets 210 may also be structured to allocate respective location conditions to one location data set 210, or may redundantly store location conditions in two or more location data sets 210 (e.g., a first location data set 210 may contain only the location conditions of greatest severity and may be widely distributed to all users in a general area, and a second location data set 210 may include all location conditions for a smaller region and may be distributed only to the users in or near the smaller region). As a third example, location data sets 210 may be recorded in many formats, such as human-readable text, text markup (e.g., XML) that facilitates automated processing, or binary formats. The location data set 210 may also be structured in various ways, such as an ordered or unordered sequence of records; a search-oriented data structure such as a B-tree or a hashtable; or data structures specialized for location-based information, such as quadtrees. Additional data features may also be included, such as checksums that verify the integrity of the data, encryption that limits the receipt of the data set to selected devices or users, compression that reduces the size of the location data set 210 without loss, and a digital signature that may be tested to verify the authenticity of the location data set 210. Those of ordinary skill in the art may devise many variations in the scenarios in which the techniques presented herein may be utilized, and in the variations of devices and architectures used to achieve the application of the techniques presented herein.

D2. Receiving and Evaluating Location Condition Reports

A second aspect that may vary among embodiments of these techniques relates to the manner of soliciting, collecting, and evaluating location reports 204 provided by the user 202. As a first variation of this second aspect, the user 202 may spontaneously provide a location condition report 204; e.g., after witnessing or encountering a location condition 106, the user 202 may begin speaking a location condition report 204 to the device. As a second variation of this second aspect, the device may solicit the user 202 to provide a location condition report 204. As a first example, the device may solicit a location condition report 204 based on detected user characteristics, such as driving speed or behavior. For example, the device may be configured to identify user characteristic of the user 202 (e.g., physiological characteristics such as heart rate, breathing rate, and stress or tension), and/or of the environment (e.g., temperature, speed, direction, altitude, vibration, and indications of physical impact), and when such user characteristics indicate an unusual result or an event of interest, the device may generate a location condition query 214 associated with the user characteristics and present the location condition query 214 to the user 202.

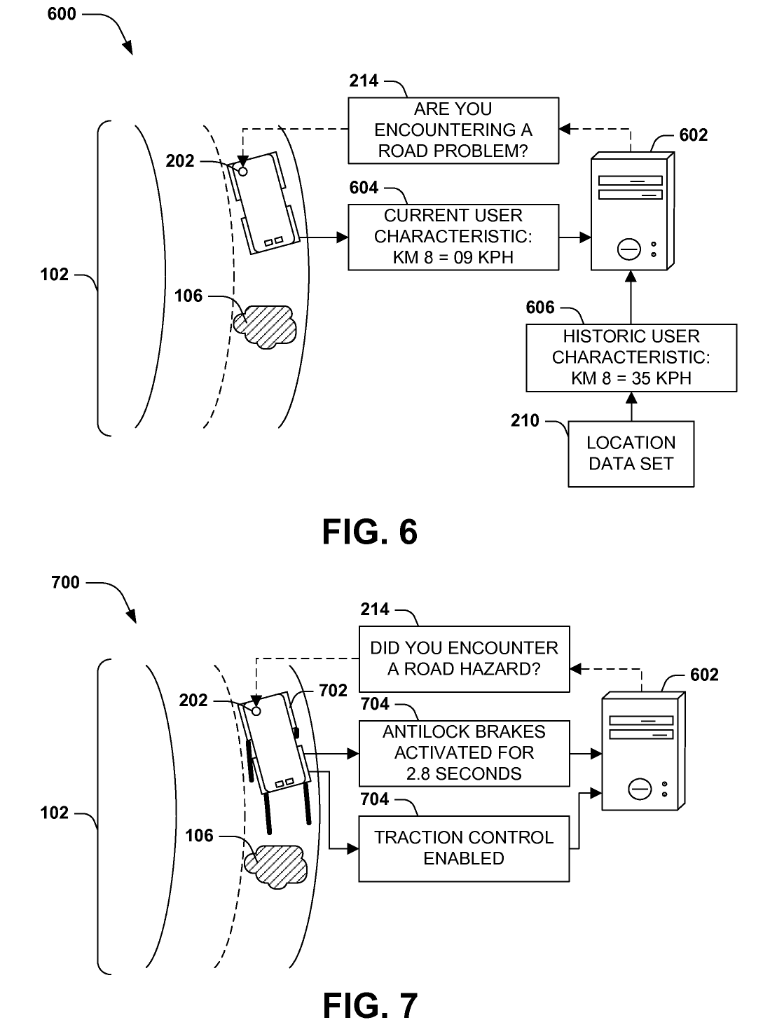

FIG. 6 presents an illustration of an exemplary scenario 600 presenting a first example of a solicitation of a location condition report 204, based on a detection of user characteristics and a comparison with historic user characteristics for the same location 102. In this exemplary scenario 600, a user device 602 is configured to detect user characteristics 604 such as the current rate of travel at a current location 102, and to compare such current user characteristics 604 with historic user characteristics 606 stored a location data set 210 for the location 102, e.g., the typical rate of travel of the user in the location 102. If the user device 602 identifies a user characteristic change in the user characteristics (e.g., a significantly slower rate of travel), the user device 602 may generate a location condition query 214 and may present the location condition query 214 to the user 202 to solicit information about the current location conditions 106 of the location 102.

FIG. 7 presents an illustration 700 of a second example of a solicitation of a location condition report 204 based on integration with vehicle telemetry. In this exemplary scenario 600, a user device 602 is configured to interface with a telemetry system of a vehicle 702 in order to receive various telemetry data items 704, such as the state of various vehicle sensors and control systems. When the user device 602 detects an unusual set of telemetry data items 704 (e.g., an activation of the braking system for an extended duration and a current invocation of a traction control system, such as an anti-skid or wheel coordination system), the user device 602 may infer that an unusual event has occurred, and may generate a location condition query 214 soliciting information from the user 202 describing a location condition 106 of the location 102 that resulted in the unusual telemetry data items 704. These and other types of user characteristics 604, including a combination thereof, may be detected by the user device 602 and may prompt the generation and presentation of a location condition query 214.

As a third variation of this second aspect, a device may generate and preset location condition queries 214 to the user 202 in order to confirm, clarify, and/or supplement other information previously received from the user 202 or other users 202. As a first example, the user 202 may generate a user location report 204 that is ambiguous or unclear (e.g., voice input that is noisy or otherwise difficult to parse), and a location condition query 214 may be generated to request information clarifying the prior location condition report 214 (e.g., “did you say that you encountered ice?”) As a second example, a location condition query 214 may be generated to solicit additional information about a previously received location condition report 204 (e.g., “you reported an accident; was the accident located with respect to the road?”) As a third example, a server 206 or other device may receive a location condition query 204 from a first user 202, and may seek to confirm the reported information with other users 202. For example, upon receiving a location condition report 204 of a location condition 106 from a first user 202 with respect to a location 102, the server 206 may identify other users 202 in the vicinity of the location 102, and may generate and send a location condition query 204 to the other users 202 (e.g., “an accident has been reported in your area; do you see an accident?”) As a fourth example, a location condition query 214 may be generated to determine the current state and persistence of a previously reported location condition 106 (e.g., “you previously reported heavy rain; is it still raining?”) Such location condition queries 214 may be generated and presented in order to improve the accuracy, depth, and reliability of information, which may be incorrectly reported by a user 202, or which may become stale over time. For example, a location data set 210 accessed by a server 260 may indicate, for respective location conditions 106 of respective locations 102, a location condition confidence, such as a predicted reliability or accuracy of the location condition 106. A high location condition confidence may indicate many recent and consistent reports of the location condition 106 from many users 102, while a low location condition confidence may indicate inconsistent reports or details of the location condition 106, or a lack of recent reports implying a resolution of a location condition 106. The server 206 and/or devices may seek to improve the accuracy of a location data set 210 by generating location condition queries 214, and presenting such location condition queries 214 to users 102, to confirm or correct location conditions 106 having a location condition confidence below a location condition confidence threshold (e.g., “reports indicated standing water in the road near your area yesterday; do you see any such conditions?”)

As a fourth variation of this second aspect, respect location condition reports 204 may be solicited and/or gathered from various users 202 through various communications mechanisms. As a first example, the device may present information to the user through a visual medium, such as displaying information on a dedicated component, on a display component of a multipurpose device such as a navigation device or mobile phone, or on an environmental display component, such as display-capable glasses or goggles or within the viewport or windshield of a vehicle. The device may also receive information from the user through a visual mechanism, such as eye-tracking or a visual interpretation of hand gestures. As a second example, the device may present and/or receive information through auditory channels, such as presenting information using rendered or pre-recorded speech or sounds, and/or by receiving voice input from the user 202. As a third example, the device may receive information from the user through various input components (e.g., a keyboard, a mouse, a trackball, a pointing device, or a touchscreen). As a fourth example, the device may communicate with the user 202 through various tactile mechanisms, such as providing information in the form of vibration. As a fifth example, the device may communicate with the user 202 through independent and/or general mechanisms, such as email communications or simple message service (SMS) messages. In the particular context of users 202 communicating with a device in an attention-demanding circumstance, such as while operating a vehicle, it may be advantageous to configure the device to communicate with the user 202 in a manner that conserves the attention of the user 202. For example, solely voice-based communications may be particularly suitable for communicating a large amount of information with the user in a rapid and natural manner while reducing the attention diversion of the user 202 from operating the vehicle (e.g., enabling the user 202 to interact with the device without breaking eye contact with the environment). For example, the device comprising a voice communication mode, involving presenting location condition queries 214 to the user 202 as location condition voice queries that are spoken to the user 202, and receiving location condition voice reports spoken by the user 202. Moreover, a device may be configured to communicate with the user 202 differently in different contexts. For example, the device may be configured to detect user characteristics determinative of a vehicle operation mode (e.g., a rate of travel above ten kilometers per hour); may communicate with the user in the voice communication mode within in the vehicle operation mode; and may also comprise a second communication mode (e.g., a visual communication mode) used to communicate with the user 202 while operating outside of the vehicle operation mode.

As a fifth variation of this second aspect, communication with user 202 may be structured in various ways, e.g., a menu-based system interacting with the user 202 according to a scripted dialog with multiple-choice answers, or a keyword-based system that detects various keywords having known semantic meanings (e.g., a database of common words, such as “accident,” “rain,” “pothole,” “debris,” “ice,” “snow,” and “standing water”), and the system may detect and extract keywords to infer the type of location condition 106 reported by the user 102. Alternatively, natural-language processing techniques and user interfaces may be utilized to interact with the user in a native language of the user 202.

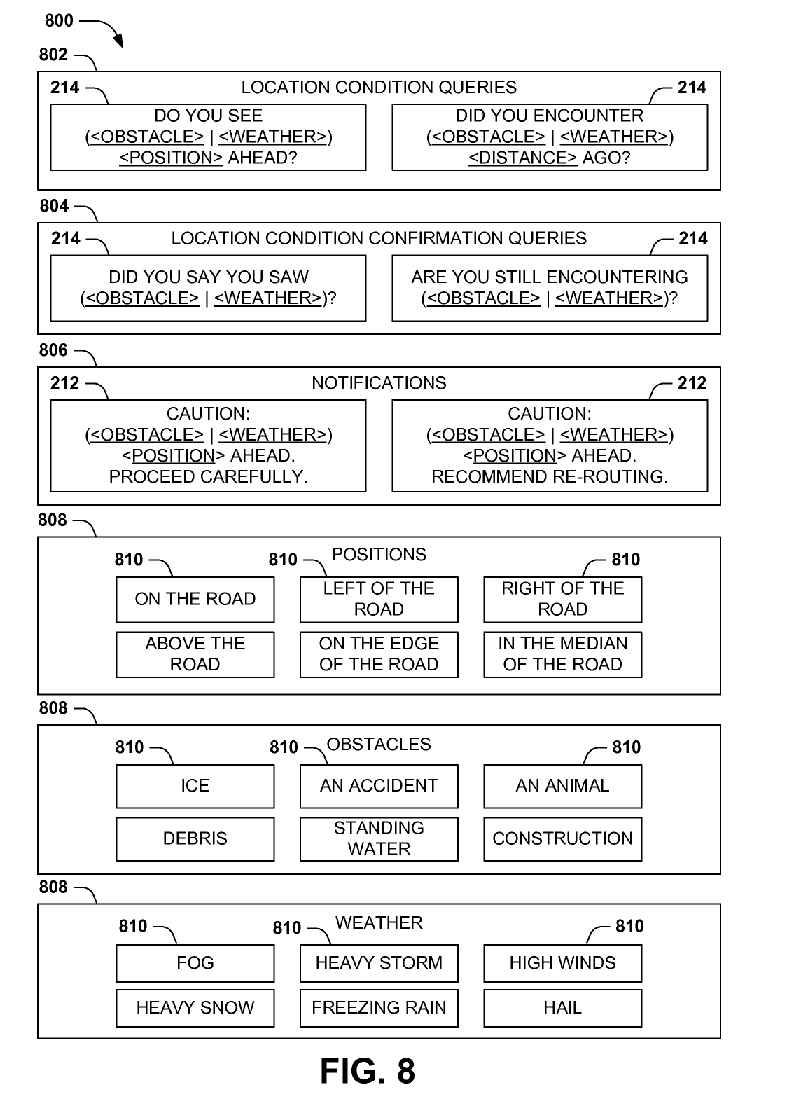

As a first example of this fifth variation of this second aspect, query templates may be used to generate natural-language queries to be presented to the user 202 as location condition queries 214, and the location condition report 204 of the user 202 may be evaluated using a natural language speech processing technique. FIG. 8 presents an illustration of an exemplary scenario 800 featuring a natural-language template set that may be used to generate location condition queries 206 communicating with the user 202 in a native language. For example, the natural-language template set may include location condition query templates 802 for location condition queries 214 soliciting additional information; location condition confirmation queries 804 for location condition query templates confirming information about previously received location conditions 106; and notification templates 806 of notifications 212 that may be presented to inform users 202 of various location conditions 106. Additionally, the natural-language template set may include many natural-language options 810 describing various types of natural-language option types 808 included in such query templates, such as descriptors of positions where location conditions 106 may arise, obstacles that may be involved in location conditions 106, and weather conditions. A device 510 (such as a user device 602 or server 206) may utilize such query templates to generate natural-language queries in the native language of the user 202, and may present such natural-language queries to the user 202 in a spoken or written manner.

As a second example of this fifth variation of this second aspect, language input received from a user 202 (both structured input and natural-language input) may be parsed in various ways. Various contextual input may also be utilized to identify the semantic meaning of a location condition report 204; e.g., the meaning of a location condition report 204 may be informed by a location condition query 214 soliciting the location condition report 204 (e.g., “yes” received in response to the query: “did you encounter ice?”) Various user characteristics 604 may also supplement the information provided in a location condition report 204 (e.g., the report “I encountered ice” may be coupled with a detected location 102 associated with telemetry data items 704 indicating the engagement of a traction control system of the vehicle 702). Additionally, a location condition parsing confidence may be computed to indicate the degree of confidence in the accuracy of the parsing of the location condition report 204 of the user 202, and for location condition reports 204 having a low location condition parsing confidence, a location condition confirmation query may be generated and presented to the same user 202 or other users 202. Alternatively or additionally, as a “mechanical Turk” interpretation technique, a server 206 or other device may be in communication with human interpreters who may be called upon to interpret location condition reports 204 having a low location condition parsing confidence, and may interpret the location condition report 204 as a set of location conditions 106 identified by the human interpreter as having been reported in the location condition report 204. Those of ordinary skill in the art may identify many ways of configuring devices to interact with users 202 to solicit, receive, interpret, and utilize location condition reports 204 in accordance with the techniques presented herein.

D3. Uses of Location Conditions

A third aspect that may vary among embodiments of these techniques relates to the range of uses of a location data set 210 comprising, for respective locations 102, location conditions 106 of the location 102 extracted from location condition reports 204 received from users 202 according to the techniques presented herein. As a first example, the location data set 210 may be used to present updated traffic information, e.g., an annotation of the detail, causes, severity, and projected duration of traffic congestion. Such uses may also include the projection of traffic congestion that has not yet developed; e.g., a location condition 106 indicating a report of a traffic accident may enable a projection of traffic congestion developing in the locations 102 leading up to the site of the traffic accident. As a second example, a device may identify users 202 in the proximity of a location 102 having a particular location condition 106, and may present notifications 212 of the location condition 106 (e.g., “caution: ice was reported in your area”). Additionally, such notifications 212 may be presented to users 202 who, although not yet proximate to the location 102, are traveling along a route including the location 102, which may enable the user to select a new route. Additionally, the location conditions 106 may also augment routing decisions in response to considerations other than traffic congestion; e.g., a dangerous location condition 102 along an infrequently traveled road, such as the presence of animals on a rural roadway, may not result in traffic congestion, but may prompt a re-routing to avoid the dangerous location condition 106. As a third example, the location conditions 106 of respective locations 102 may be of use to various types of recipients, including end users, businesses, organizations, government agencies (including police, fire, and medical personnel), and automated processes that may consume and utilize the location conditions 106 to various ends. Those of ordinary skill in the art may devise many such uses of the location data set 210 supplemented with location conditions 106 extracted from location condition reports 204 submitted by users 202 in accordance with the techniques presented herein.

### E. Computing Environment

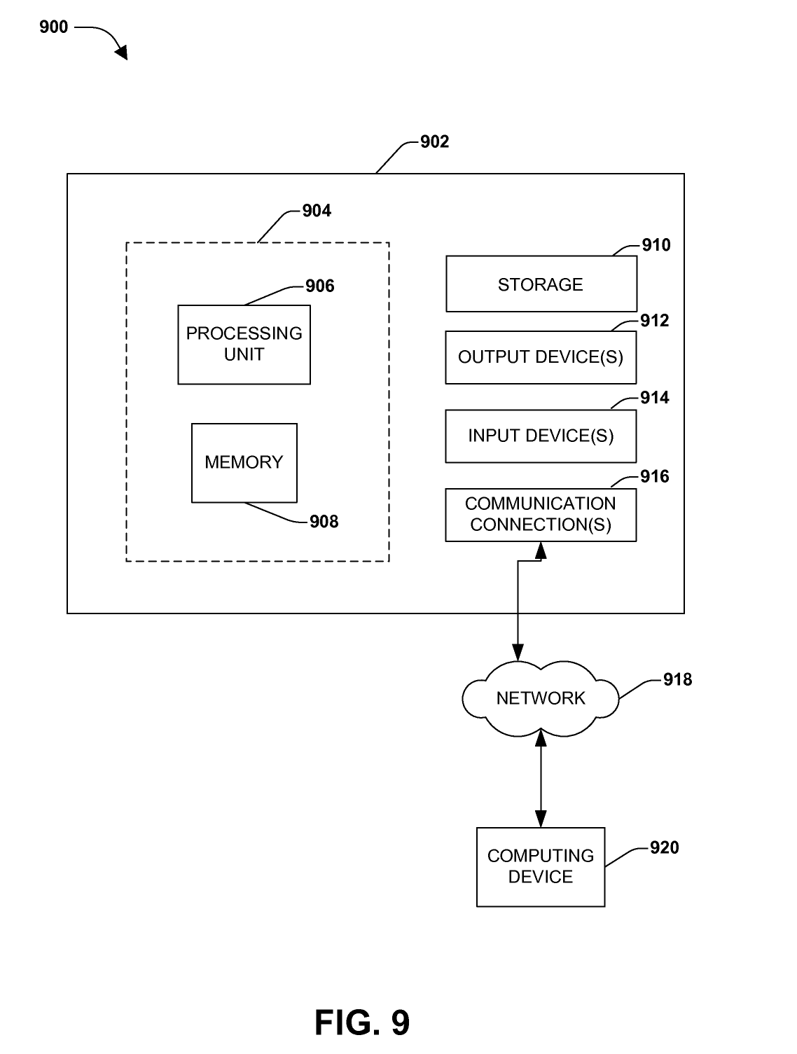

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 902 configured to implement one or more embodiments provided herein. In one configuration, computing device 902 includes at least one processing unit 906 and memory 908. Depending on the exact configuration and type of computing device, memory 908 may be volatile (such as RAM, for example), non-volatile (such as ROM, flash memory, etc., for example) or some combination of the two. This configuration is illustrated in FIG. 9 by dashed line 904.

In other embodiments, device 902 may include additional features and/or functionality. For example, device 902 may also include additional storage (e.g., removable and/or non-removable) including, but not limited to, magnetic storage, optical storage, and the like. Such additional storage is illustrated in FIG. 9 by storage 910. In one embodiment, computer readable instructions to implement one or more embodiments provided herein may be in storage 910. Storage 910 may also store other computer readable instructions to implement an operating system, an application program, and the like. Computer readable instructions may be loaded in memory 908 for execution by processing unit 906, for example.

The term “computer readable media” as used herein includes computer storage media. Computer storage media includes volatile and nonvolatile, removable and non-removable media implemented in any method or technology for storage of information such as computer readable instructions or other data. Memory 908 and storage 910 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 902. Any such computer storage media may be part of device 902.

Device 902 may also include communication connection(s) 916 that allows device 902 to communicate with other devices. Communication connection(s) 916 may include, but is not limited to, a modem, a Network Interface Card (NIC), an integrated network interface, a radio frequency transmitter/receiver, an infrared port, a USB connection, or other interfaces for connecting computing device 902 to other computing devices. Communication connection(s) 916 may include a wired connection or a wireless connection. Communication connection(s) 916 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 902 may include input device(s) 914 such as keyboard, mouse, pen, voice input device, touch input device, infrared cameras, video input devices, and/or any other input device. Output device(s) 912 such as one or more displays, speakers, printers, and/or any other output device may also be included in device 902. Input device(s) 914 and output device(s) 912 may be connected to device 902 via a wired connection, wireless connection, or any combination thereof. In one embodiment, an input device or an output device from another computing device may be used as input device(s) 914 or output device(s) 912 for computing device 902.

Components of computing device 902 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 902 may be interconnected by a network. For example, memory 908 may be comprised of multiple physical memory units located in different physical locations interconnected by a network.

Those skilled in the art will realize that storage devices utilized to store computer readable instructions may be distributed across a network. For example, a computing device 920 accessible via network 918 may store computer readable instructions to implement one or more embodiments provided herein. Computing device 902 may access computing device 920 and download a part or all of the computer readable instructions for execution. Alternatively, computing device 902 may download pieces of the computer readable instructions, as needed, or some instructions may be executed at computing device 902 and some at computing device 920.

### F. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of querying users regarding location conditions of locations using a device having a processor and having access to a location data set, the method comprising:
executing on the processor instructions configured to:
receive from a user a location condition report associated with a location of the user;
parse the location condition report of the user to extract at least one location condition of the location; and
add the location condition of the location to the location data set.

2. The method of claim 1:
the instructions configured to:
identify a user characteristic of a user;
generate a location condition query associated with the user characteristic of the user and the location of the user; and
present the location condition query to the user.

3. The method of claim 2:
the device having access to historic user characteristics of the user for respective locations; and
identifying the user characteristic of the user comprising:
identifying a current user characteristic of the location of the user; and
compare the current user characteristic of the location with historic user characteristics of the location to identify a user characteristic change at the location.

4. The method of claim 2:
the device configured to receive telemetry data items from a vehicle operated by the user; and
identifying the user characteristic comprising: receiving a telemetry data item from the vehicle operated by the user.

5. The method of claim 2, the location condition report received from the user in response to the location condition query.

6. The method of claim 5:
the device comprising a voice communication mode;
presenting the location condition query to the user within the voice communication mode comprising: presenting a location condition voice query spoken to the user; and
receiving the location condition report within the voice communication mode comprising: receiving from the user a location condition voice report.

7. The method of claim 6:
the device comprising a second communication mode; and
the instructions configured to, upon identifying the user characteristic of the user, determine a vehicle operation mode of the user; and
presenting the location condition query to the user comprising:
within a vehicle operation mode, presenting the location condition query to the user in the voice communication mode; and
outside a vehicle operation mode, presenting the location condition query to the user in the second communication mode.

8. The method of claim 2:
the user operating a user device;
the device comprising a location condition server configured to interface with user devices of respective users;
receiving the location condition report comprising: receiving from a user device of a user:
a location condition report, and
a location detected by the device and associated with the location condition report; and
presenting the location condition query to the user comprising: requesting the user device of the user to present the location condition query to the user.

9. The method of claim 1:
the instructions configured to:
identify a selected location condition of a selected location;
identify a user having a location proximate to the selected location;
generate a location condition detail query associated with the selected location condition; and
present the location condition detail query to the user; and
the location condition report received from the user in response to the location condition detail query.

10. The method of claim 9:
the selected location condition extracted from at least one location condition report received from at least one user; and
identifying the user comprising: identifying at least one user proximate to the selected location and submitting a location condition report of the selected location condition.

11. The method of claim 9:
the device comprising at least one location condition detail query template for location condition detail queries of a location condition detail query type; and
generating the location condition detail query comprising:
identifying a location condition detail query type of the selected location condition of the selected location;
select a selected location condition detail query template for the location condition detail query type; and
using the selected location condition detail query template and the selected location condition, generate the location condition detail query.

12. The method of claim 9, parsing the location condition report received from user comprising: parsing the location condition report responsive to the location condition detail query.

13. The method of claim 1, the instructions configured to determine a location condition report parsing confidence of the location condition report.

14. The method of claim 13, the instructions configured to, upon determining, for a location condition report received from a user, a location condition parsing confidence below a report parsing confidence threshold:
generate a location condition confirmation query confirming the location condition of the location; and
present the location condition confirmation query to the user.

15. The method of claim 13:
the device communicating with at least one human interpreter; and
the instructions configured to, upon determining a location condition report parsing confidence below a location condition report parsing confidence threshold, request a human interpreter to extract location conditions from the location condition report; and
extracting the location conditions of the location comprising: receiving at least one location condition from the human interpreter.

16. The method of claim 1, the instructions configured to:
identify selected users proximate to the location of the location condition report; and
notify the selected users of the location condition report.

17. The method of claim 1:
the device having access to a traffic condition data set indicating traffic conditions for respective locations; and
the instructions configured to update the traffic condition of the location in the traffic condition data set based on the location condition of the location.

18. The method of claim 17:
respective users having a route respectively associated with at least one location; and
the instructions configured to:
identify selected users having a route including the location of the location condition report, and
update the routes of the selected users based on the traffic condition of the location.

19. The method of claim 1, the instructions configured to send at least one location condition of at least one location in the location data set to at least one recipient of a recipient type selected from a recipient type set including:
an end user;
a business;
an organization;
a government agency; and
an automated process.

20. A method of querying a user regarding location conditions of locations using a device having a processor and communicating with a server having access to a location data set, the method comprising:
executing on the processor instructions configured to:
upon receiving from the server a location condition query associated with a location, present the location condition query to the user;
upon receiving a location condition report from the user:
detect a location of the user associated with the location condition report; and
send the location and the location condition report to the server; and
upon receiving from the server a location condition of a location proximate to the user, present the location condition to the user.

21. A computer-readable storage medium comprising instructions that, when executed on a processor of a device having access to a location data set, cause the device to query users regarding location conditions of locations by:
receiving from a user a location condition report associated with a location of the user;
parsing the location condition report of the user to extract at least one location condition of the location; and
adding the location condition of the location to the location data set.
